(19) United States
(12) Patent Application Publication
(10) Pub. No.: US 2009/0207616 A1
(43) Pub. Date: Aug. 20, 2009

(54) LIGHT FIXTURE FOR ILLUMINATING BUILDING SURFACES

(75) Inventor: Markus Gorres, Dortmund (DE)

Correspondence Address: K.F. ROSS P.C., 5683 RIVERDALE AVENUE, SUITE 203 BOX 900, BRONX, NY, 10471-0900, US

(73) Assignee: ERCO Leuchten GmbH

(21) Appl. No.: 12/032,740

(22) Filed: Feb. 18, 2008

(51) Int. Cl. F21V 17/02

(52) U.S. Cl. 362/282

(57) ABSTRACT

A light fixture (14) is shown and described for illuminating a building surface (19) and having a fixture housing (26) holding a bowl-shaped reflector (11) with a generally rotation-symmetrical (11) outer surface centered on a longitudinal center axis (M) and an inner surface (16) provided with a plurality of segments (15) for producing a rotationally asymmetrical illuminated zone.

The novelty is, inter alia, that the fixture housing has a rotary bearing (29) for the reflector so as to enable rotation of the reflector about its central longitudinal axis, and in that a device (30) is provided on the fixture housing for rotationally arresting the reflector, the device fixing the reflector relative to the fixture housing in any of a plurality of angularly offset positions.

The invention relates to a light fixture for illuminating building surfaces as specified in the preamble of claim 1.

Applicant's German patent application DE 10 2004 042 915 [U.S. Pat. No. 7,188,975] discloses a light fixture for illuminating building surfaces in which a bowl-shaped reflector is described that is of a rotation-symmetrical shape in terms of its outside shape. In order to achieve a homogenous, rotationally-symmetrical distribution of light for the building surface, the inside of the reflector is fitted with numerous segment, known as facets. Each segment has an individually computed surface and has been optimized in terms of its surface shape through elaborate computer simulations.

German patent application DE 10 2007 305 528 A1, German patent application DE 10 2007 25 396 A1, and German patent application DE 10 2007 044 963 A1, all of applicant and all post-published, describe light fixtures as specified in the preamble of claim 1. In each case here, reflectors are provided in a fixture housing that has an outside shape that is essentially rotation symmetrical, and by which elements, however, non-rotation-symmetrical distributions of light on a building surface are achievable.

To avoid repetitions, and also for purposes of reference, including to individual features, the content of the above-mentioned previously published patent application and the content of the three subsequently published patent applications of the Applicant are also incorporated by reference.

The problem to be solved by the invention is to further develop a light fixture as specified in the preamble of claim 1 so as to provide convenient and reliable operation.

The invention solves this problem by the features of claim 1, in particular, by those of the characterizing clause, and is accordingly characterized in that the fixture housing has a rotary bearing for the reflector so as to enable rotation of the reflector about its central longitudinal axis, and in that a device is provided on the fixture housing for rotationally arresting the reflector, the device fixing the reflector relative to the fixture housing in any of a plurality of angularly offset positions.

The principle of the invention consists in making it possible prior to installation for the reflector to be rotated on the fixture housing, the reflector being rotatable prior to installation about its center longitudinal axis. This enables light to be cast rotationally asymmetrically on the building surface. The device for rotationally locking the reflector can then be used to fix the desired set angular position and thereby lock it in. This provides especially convenient manipulation and adjustment. At the same time, the device for rotational locking ensures permanent locking-in of the adjusted position, with the result that no readjustment is required.

The invention relates to any light fixture for illuminating building surfaces. This is understood also to include light fixtures that illuminate partial surfaces of buildings or external surfaces, optionally also objects such as paintings and statues.

The light fixture according to the invention comprises a fixture housing of any shape. The fixture housing is preferably composed of a dimensionally stable, for example, metal material, and completely contains the reflector. In addition, the reflector is also preferably provided completely within an envelope of the fixture housing and does not project beyond the fixture housing.

A reflector can be mounted within the fixture housing. The reflector has an outside shape or wall shaped like a bowl. With respect to its base form, the shape of the reflector is selected so as to be rotation symmetrical about its center longitudinal axis. In cross-section the reflector preferably has an essentially parabolic shape. It extends from the vertex to a free rim or collar. In the region of the free rim, that is, near the light output, the reflector has, for example, a flange-like, circumferential collar surrounding the light-output opening, which collar can serve for attachment of the reflector to the fixture housing. An installation aperture for a light source, i.e. a lamp, is provided at the vertex.

A plurality of segments is provided on the highly reflective inner face of the reflector. The segments preferably have curved surfaces directed toward the interior of the reflector. The surfaces of the individual segments are individually variously curved in order to create on the building surface a desired illuminated zone that is rotationally asymmetrical about the center longitudinal axis of the reflector. The configuration of the segments can be selected such that segments of identical shape are provided rotationally asymmetrically on the inner surface of the reflector.

Provision can also be made whereby only a few angularly limited sections of the inside of the reflector are provided with segments, the remaining sections of the inner surface of the reflector being left smooth, or at least free of segments.

Alternatively and preferably, the entire inside of the reflector is fitted with segments, different segments—for example, ones with variously curved surfaces, various sizes, various radii, or various configuration patterns—being distributed angularly along the inner surface of the reflector.

When installed, the light source extends through an installation aperture in the vertex of the reflector. Starting from the light source, most of the emitted light is reflected first from the surfaces of the segments before the light strikes the building surface. Due to various alignments of the surfaces of the segments, and the different surface curvatures of the segments, a nonhomogeneous illumination of the building surface is achieved. For example, an oval or oblong illuminated zone can be obtained. Using a reflector of an essentially rotation-symmetrical outside shape, and, for example, a circular light-emitting aperture for the fixture housing, it is possible to obtain a shape for the illuminated zone deviating from the circular shape, or an illumination of the building surface that is inhomogeneous along any desired shape.

According to the invention, a rotary bearing for the reflector is provided on the light fixture. The rotary bearing can be any type of device that rotatably supports the reflector in the fixture housing prior to installation. Possible rotary bearings to be considered include, for example, shoulder surfaces or slide surfaces that allow the desired rotation. As a result, the reflector can be rotated about its center longitudinal axis, preferably into any desired 360° position. The reflector is preferably rotatable by at least 360° relative to the fixture housing.

In an alternative embodiment of the invention, the reflector is rotatable only along through an angle of, for example, 90° relative to fixture housing. The angular movement can be limited by stops on one or both parts.

A device to rotationally lock is furthermore provided according to the invention on the light fixture. This device enables a selected angular position of the reflector to be secured and locked. The set angular position of the reflector can thus be ensured to be maintained in a lasting manner.

For example, in the case of a light fixture according to the invention mounted on a high ceiling, a service person standing on a tall ladder can, for example, rotate the reflector by hand, for example, even with the lamp turned on, and immediately observe whether the desired effect occurs on the building surface. If the desired angular position for the reflector, or the desired angular position of the illuminated zone on the building surface to be illuminated has been achieved, the service person can release the reflector and actuate the angular locking device so as to secure the reflector.

For example, the angular locking device can comprise a locking screw or other appropriate clamping element or locking element. The angular locking device here can preferably have a clamping surface that pretensions the reflector against an opposite clamping surface.

Also comprised by the invention is an arrangement in which the reflector is urged by one or more springs against a retaining collar provided at the front in the light-output opening. A change in the angular position of the reflector can be effected, for example, by displacing the reflector against the force of the spring, e.g. rearward in the light-output opening, or pressed and then rotated. Once the desired angular position has been reached, the service person simply releases the reflector so that the spring can again in turn apply force on the reflector, and can thereby set the adjusted angular position for the reflector.

What is furthermore comprised by the invention is an approach whereby the reflector is shaped so as to rotatable together with a retaining ring or clamping ring mountable on a fixture housing, and whereby the fixture housing provides a rotary bearing for the clamping ring. In this embodiment of the invention, the clamping ring and reflector can be rotated together about the center longitudinal axis of the reflector. In this case, the adjustment and securing of the angular position of the clamping ring are effected relative to the stationary fixture housing. The reflector in this embodiment of the invention is not rotatable relative to the retaining ring or clamping ring, but only together with this ring.

Finally, an approach is conceivable whereby the fixture housing comprises a removably attachable retaining body, for example, a clamping ring, retaining ring, or mounting ring, and whereby the reflector is rotatable relative to the retaining body. In this case, the rotary bearing for the reflector can for example also be provided by the retaining body. The ring in this case is considered to be a constituent part of the fixture housing.

In particular, the retaining body can also be provided by a interchangeable reflector ring. The interchangeable reflector ring is, for example, an element that rotatably supports the reflector and that is removably attachable to the fixture housing, for example lockable by a bayonet-type connection.

The rotary bearing can comprise shoulders that corresponding opposite shoulders of the reflector—or of a retaining ring—engage. The shoulders are preferably provided three or more sites spaced from each other, thereby providing a flat support surface defining a plane. However, it is also possible for shoulders to extend angularly around the reflector.

A collar is mounted on the reflector—preferably on its outer edge. The collar provides especially easy fixation of the reflector on a fixture housing. Provision of a collar also enables angular-positioning formations to be provided very easily.

The reflector according to the invention is preferably made of aluminum and is produced by a metal-spinning process as described in detail in the applicant's patent applications mentioned in the introduction. This is an especially simple way to provide a circumferential collar on the outer edge of the reflector.

The angular locking device can have a clamping surface that clamps the reflector against an opposite clamping surface. For example, the clamping surface can be provided on a clamping ring or retaining ring located at the front in the light-output opening. The clamping ring can thus be screwed, for example, against the housing, thereby at the same time contributing to the pretensioning or clamping or retaining of the reflector. In this way, the reflector can be pressed against the opposite clamping surface. For example, the previously described collar can be pinched between its clamping surface and the opposite clamping surface.

In an embodiment of the invention, the angular locking device has at least one spring. This can apply a gripping force on the reflector and secure the adjusted angular position of the reflector relative to the fixture housing by means of this force.

Due to the application of this gripping force, the reflector can be pressed against the retaining surface. To undo the rotationally locking position, an opposite force must be applied that is directed against the gripping force of the spring and exceeds this force. By applying an opposite force the reflector can then be rotated about its center longitudinal axis until a new desired angular position for the reflector is obtained.

The numerous segments each have a surface curved inward toward the interior of the reflector. The curvatures of the individual surfaces can be optimized through elaborate computer simulations. Each surface is preferably doubly curved. It is possible to utilize spherical, aspheric, or also cylindrical segment surfaces. The segments can also be partially undercut, as is described in part in the Applicant's post-published applications cited in the introduction.

In one embodiment of the invention, a lamp can be provided inside the reflector. Preferably, a single lamp is insertable through an installation aperture in the vertex of the reflector. What is furthermore advantageous is that the lamp is a light source with a small discharge volume or light-emitting volume, with the result that one can speak essentially in terms of a point light source. What is advantageous furthermore is that the discharge volume or light-emitting volume of the light source is able to be provided essentially at the focal point, or close to the focal point, of the reflector.

The installation aperture preferably has an inside diameter that is greater than the outside diameter of the lamp.

This enables the lamp to be fixedly mounted in a socket relative to the fixture housing, while the reflector is rotatable about its center longitudinal axis for the purpose of orienting the light distribution. As a result, rotation of the reflector can be effected about its center longitudinal axis for the purpose of orienting the reflector when the lamp is turned on.

The invention furthermore solves the posed problem by means of the features of claim 13.

The principle of the invention essentially consists in an approach whereby the reflector has a first angular-positioning formation and the mounting seat for the reflector element has at least one second formation. The first angular-positioning formation and second formation must be aligned in order to enable axial insertion of the reflector into the fixture housing. This achieves at least one defined angular position for the reflector relative to the fixture housing.

As a result, the lighting planner can, for example, define in advance which position the fixture housing must occupy. During the installation on site, the reflector need then only be inserted such that the positioning formation on the reflector is aligned with the second formation on the fixture housing.

In one embodiment of this invention, rotation of the reflector relative to the mounting seat is precluded. As a result, only one single angular position is possible for the reflector in the mounting seat as defined by the first angular-positioning formation and second formation.

In an alternative embodiment of this invention, rotation of the reflector relative to the mounting seat is generally not impeded by the first angular-positioning formation and the second formation. Here the first angular-positioning formation and second formation function only to enable a specific angular position to be checked, for example, visually by a service person.

With respect to the definition of terms for the features of claim 13, reference is made to the above definition of terms for claim 1 and definition of terms applicable to the following claims.

Within the meaning of this patent application, what is designated as a mounting seat for the reflector is any structure that can hold or receive the reflector. In particular, what is designated as a mounting seat is the region of the walls of the fixture housing that in the mounted reflector is immediately adjacent this element and that retains, contacts, or encloses the reflector.

With this invention as well, it is also possible for the reflector to be mounted on a seat on the fixture housing and to be retained by a separate retaining body, retaining ring, or clamping ring on the fixture housing. Provision can also be made, however, whereby the reflector is attached together with a retaining body, e.g. with a retaining ring, to the fixture housing. In this embodiment, an angular-positioning formation can also be provided on the retaining body, and a second formation provided on the fixture housing. In this case, it is similarly advantageous if the reflector and the retaining body are fixedly attachable to each other, or are at least attachable to each other only in one possible relative angular position.

What may be conceivably used as the first angular-positioning formation on the reflector is, for example, a groove, while what may be used as the second formation is a projecting lug that has a shape complementary to the groove. By occupying the proper angular position of the reflector relative to the reflector housing and axially moving the reflector relative to the fixture housing, the groove and lug can be moved into alignment, thereby enabling the reflector to be inserted and fitted to the mounting seat. If the first angular-positioning formation and second formation are not overlapping or in an aligned configuration due to an incorrect angular position of the reflector relative to the fixture housing, the reflector in one embodiment of the invention is not movable into the mounting seat. Instead, the reflector will, for example, strike the second formation at its free rim or its collar, and prevent any further axial movement of the reflector relative to the mounting seat, and in particular, prevent it from reaching the mounting seat.

For the case in which multiple angular-positioning formations or multiple second formations are provided, what can also be provided is a synchronized or stepwise allowable rotation of the reflector through the same or different angles. If the intent is to provide, for example, rotation of the reflector relative to the fixture housing only in 20° steps along a predetermined angular region of, e.g. 180°, it is possible to provide ten second formations, or alternatively, ten angular-positioning formations.

According to the invention, it is possible to provide the first angular-positioning formation and second formation directly on the reflector and on the fixture housing. However, it is also conceivable for the reflector to be attached to the fixture housing together with the clamping ring or retaining ring. In this case, the first angular-positioning formation can also be provided on the clamping ring or retaining ring, and the second formation provided on the fixture housing.

Similarly, it is also possible for the second formation to be formed in the clamping ring, while the first angular-positioning formation formed by the reflector. In this last variant, however, it must in turn be assumed that the clamping ring or retaining ring is attachable to the fixture housing.

Finally, the invention also relates to a reflector as specified by the preamble of claim 19.

A reflector of this type is described in the Applicant's subsequently published patent applications mentioned in the introduction.

The problem solved by the invention consists in developing the reflector described in the introduction so as to provide convenient and reliable operation of a light fixture using this reflector.

The invention solves this problem by means of the features of claim 19.

An angular-positioning formation can be provided on the reflector according to the invention in the form of a mechanical coding groove or coding lug. Another conceivable approach is to provide the first angular-positioning formation by an optically or visually identifiable element, for example, by an arrow or other symbol, possibly as well by a manufacturer's brand formation. For example, in a case where a plurality of reflectors with comparable or identical light distribution characteristics are mounted on the ceiling along a wall, e.g. side by side, for the purpose of illuminating the wall, these angular-positioning formations can each be directed toward the wall. This then provides an especially simple alignment of the illuminated zone of the individual light fixtures relative to the wall.

Additional advantages of the invention are described in the non-referenced dependent claims and in the following description of the embodiments illustrated in the figures. There:

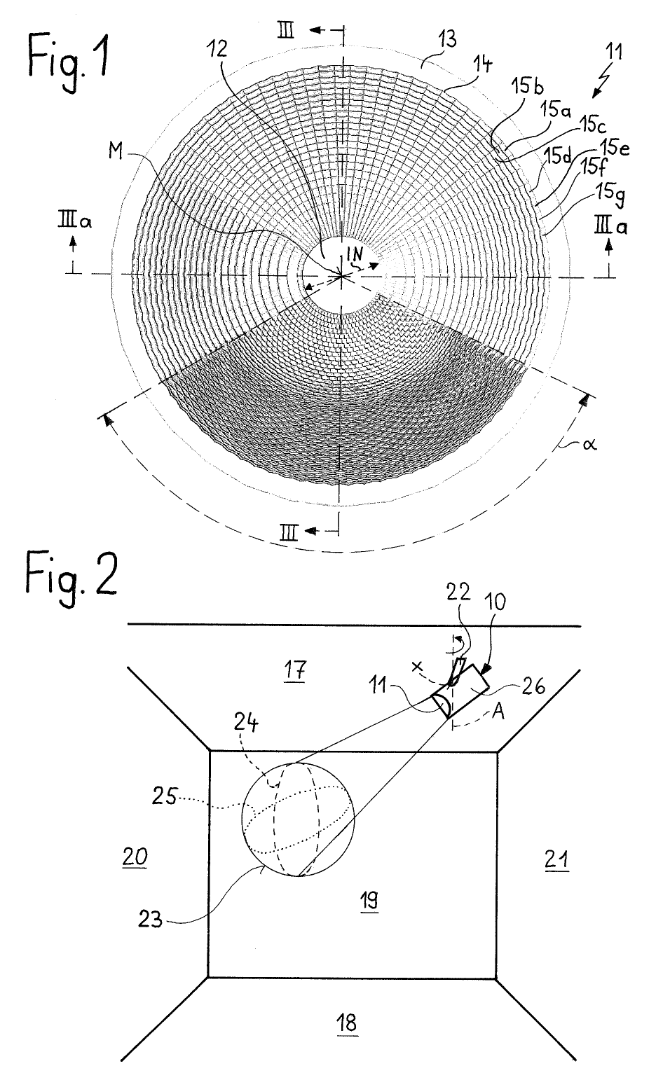

FIG. 1 is a schematic top view of a reflector for use in a light fixture according to the invention;

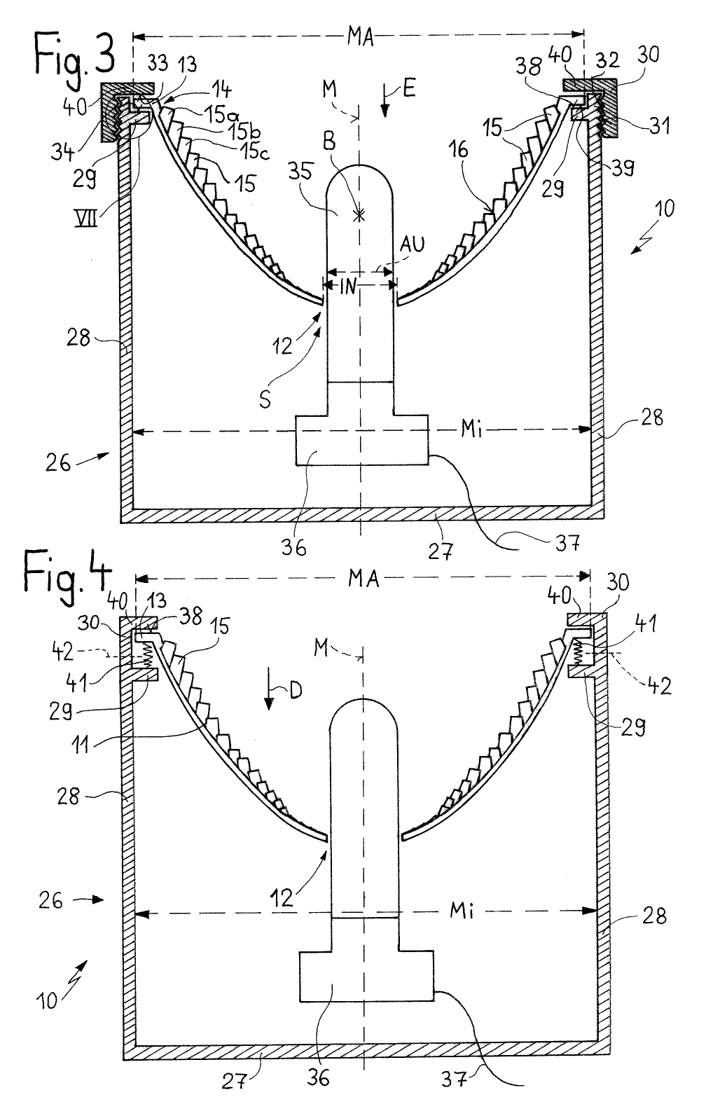

FIG. 2 is a schematic perspective view showing a first embodiment of a ceiling-mounted light fixture according to the invention that uses the reflector of FIG. 1 and illuminates a building surface;

FIG. 3 is a schematic partly sectional view showing a section through the light fixture according to the invention indicated in FIG. 2;

FIG. 4 shows an alternative embodiment of a light fixture according to the invention in a view like FIG. 3;

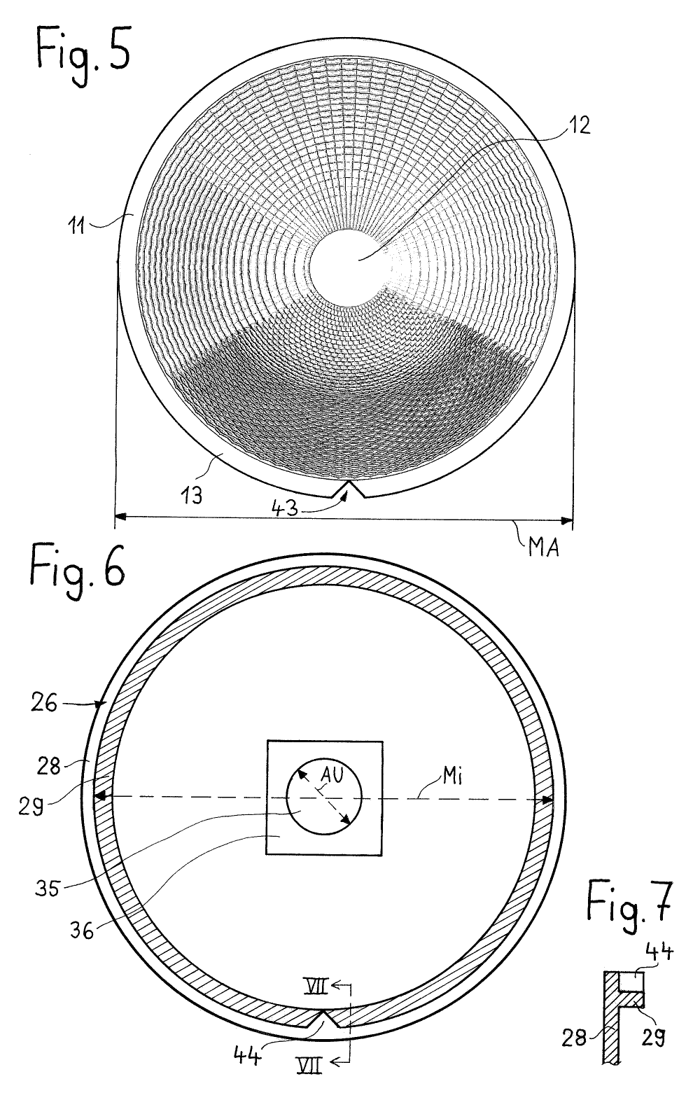

FIG. 5 is a view like FIG. 1 showing an embodiment of a reflector according to the invention with an angular-positioning formation;

FIG. 6 is a schematic partly sectional view showing an embodiment of a light fixture according to the invention with a second formation;

FIG. 7 is a schematic partly sectional view showing a wall section of the fixture housing of FIG. 6 taken on section line VII-VII of FIG. 6 as shown in circle line VII of FIG. 3;

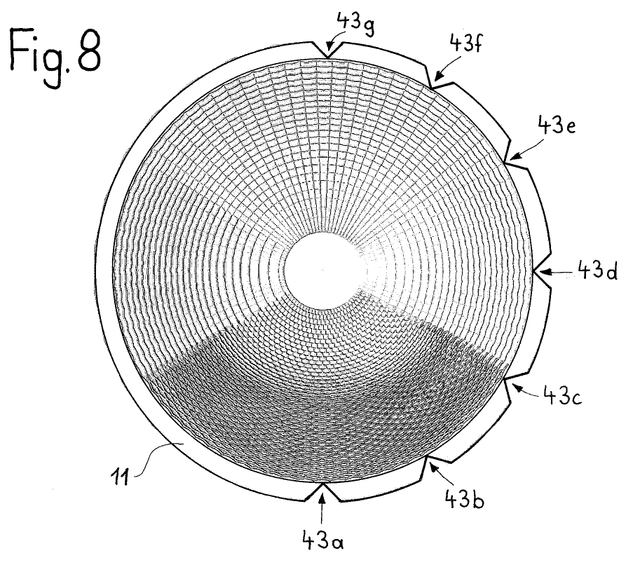

FIG. 8 shows another embodiment of the reflector according to the invention with a plurality of equidistantly oriented angular-positioning formations; and

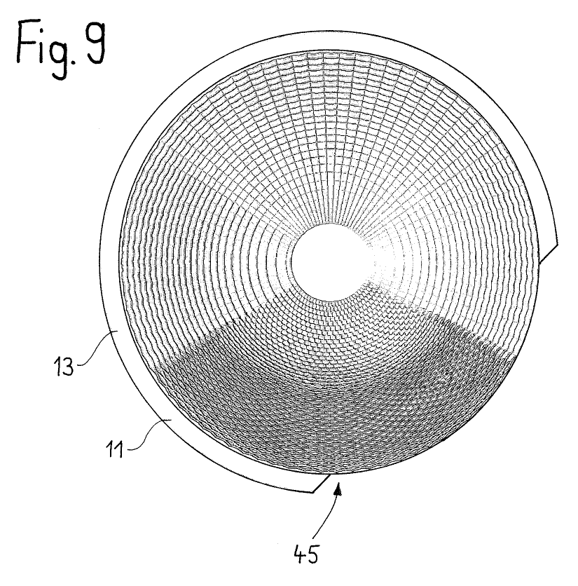

FIG. 9 shows another embodiment of a reflector according to the invention with a 90° cutout for the defining a 90° rotational motion.

The embodiments of the light fixture according to the invention, all of which are identified by 10, are now described in detail based on the figures. With respect to the description, it must first be noted that for the sake of clarity identical or comparable parts or segments are described using identical references, also in part with the addition of lower-case letters. This is done also for the purpose of simplifying different illustrated embodiments.

The light fixture 10 according to the invention, as indicated by way of example in FIGS. 2, 3 and 4, comprises a reflector 11. This is described first with reference to FIGS. 1 and 3.

The reflector 11 is essentially bowl-shaped and has an outside shape or base form that is essentially rotation symmetrical about a center longitudinal axis M. As shown in particular in the cross section of FIG. 3, the reflector 11 has an essentially parabolic shape with a the focal point shown at B. In the region of an edge or rim 14, the reflector 11 is provided with a circumferential flange-like collar 13 projecting essentially perpendicular to the center longitudinal axis M. In the region of the center longitudinal axis M, the reflector has an installation aperture 12 with an inside diameter IN. The installation aperture 12 is provided at the vertex S.

Reflector 12 [sic: 11] is provided on its inner surface 16 with a plurality of segments 15, 15a, 15b, 15c, 15d, 15e, 15f, 15g. The segments are oriented, for example in columns and rows. The columns each extend from an outer edge 14 toward the center longitudinal axis M. The rows run angularly around the imaginary center of the axis M.

FIG. 1 shows that segments 15a, 15b, 15c form a column. Other segments 15d, 15e, 15f and 15g are part of a row that runs angularly about the center longitudinal axis M.

FIG. 1 shows that the inner surface 16 of the reflector 11 along angular region a of approximately 120°, as seen by the viewer on first glance, is equipped with a different type of segments than is the remaining region of interior surface 16 of the reflector 11. In this region, the segments are narrower and have correspondingly smaller surfaces.

This illustration is intended simply to show by way of example that the purpose is to achieve a rotationally asymmetrical light distribution with the reflector 11 by using the special shape and configuration of individual segments 15a, 15b, 15c, 15d, 15e, 15f, 15g, despite the essentially rotation-symmetrical base form. This will be explained below based on FIG. 2.

FIG. 2 is a perspective view showing a room with a light fixture 10 according to the invention attached to the ceiling 17.

In FIG. 2, the light fixture 10 is designed as a spotlight, and is, for example, pivotal about an axis A running perpendicular to ceiling 17. Similarly, relative to an indicated mount 22, e.g. in the form of a mounting bracket, the light fixture 10 can also be pivotal about another axis that is identified approximately at X and runs perpendicular to the view plane of FIG. 2. The light fixture 10 can be locked in any angular position relative to the axes A and X.

It must be noted, however, that the light fixture according to the invention does not necessarily need to be rotatably supported relative to a mounting surface, but can, for example, in the case of a downlight, also be fixed relative to the mounting surface or building surface.

The purpose is to use the light fixture 10 to generate an illuminated zone 23 on a building wall 19. Alternatively, it is also conceivable, for example, for the other building walls 20, 21, or alternatively also a floor surface 18, to be illuminated. Finally, the light fixture 10 can also be attached to a floor or wall, and, for example, illuminate a ceiling surface or other building wall. Finally, it should be noted for the sake of completeness that the type and location of attachment for the light fixture 10 is not important.

Due to the rotationally asymmetrical shape or configuration of the segments 15 on the inner surface 16 of the reflector 11, the illuminated zone 23 is not homogeneous, as would be expected if the inner reflector surface 16 were smooth; instead, what is evident, as indicated in FIG. 2 by the dashed and dotted lines, are rotationally asymmetrical shapes. For the sake of simplicity, it is assumed that utilizing an appropriate light source and the reflector 11 of FIG. 1 the light fixture 10 is used to project an essentially extended, oblong illuminated zone 24, indicated in FIG. 2 by the dashed line, onto the building surface 19. An illuminated zone 24 illustrates that the surface section of the illuminated zone 24 is illuminated in a bright homogeneous manner, whereas the region of the building surface 19 lying outside the dashed line is virtually unilluminated, or not noticeably illuminated, by the light fixture 10.

As is clearly evident to the viewer of FIG. 2, the illuminated zone 24 is aligned essentially vertically, with reference to FIG. 1. However, in certain cases it may be desirable to rotate the illuminated zone 24 such that an illuminated zone 25, indicated in FIG. 2 by the dotted line, is obtained on the building surface 19. To this end, the reflector 11 is mounted, for example, rotatably in the housing 26 of the light fixture 10. This will be described below based on FIGS. 3 and 4.

FIG. 3 is a very schematic, partially sectional view showing by way of example a fixture housing 26 of a light fixture 10 according to the invention. The housing comprises a base wall 27 and side walls 28. The fixture housing 26 can have, for example, an essentially circular cross-section and have a tubular cylindrical shape. A lamp socket 36 and lamp 35 are mounted in the interior of the fixture housing 26.

Not shown in FIG. 2 is the fact that socket 36 is fixed relative to the housing 26. Electrical supply cables 37 are only suggested and can also supply the light fixture 10 from outside with operating voltage, and optionally as well with signal or control data.

The light source 35 has an outside diameter AU that is smaller than an inside diameter IN of an installation aperture 12. The center of the preferably point-type light source 35 is at or near the focal point B of the reflector 11.

An inwardly projecting flange seat 29 is provided in the region of the top free rim of the fixture housing 26 as shown in FIG. 3. The collar 13 of the reflector 11 rests on the flange 29. The reflector is rotatable about its center longitudinal axis M. A flange top face 38 contacts a collar bottom face 39, thereby providing a sliding surface or rotary bearing surface for the reflector 11. The flange 29 thereby provides a rotary bearing for the reflector.

An external thread 31 is provided in the region of the free rim of the fixture housing 26. This can fit with an internal thread 32 of a ring 30. The ring 30 has a retaining section 40 that overlaps the collar 13 of the reflector. Rotating the ring 30 about the center longitudinal axis M, causes the internal thread 32 of the ring 30 and external thread 31 of the fixture housing 26 to make a ring surface 33 move continuously toward a flange opposite clamping surface 34. When the clamping surface 33 and the collar 13 come into contact, the collar 13 of the reflector 11 is clamped securely between the ring 30 and the flange 29. Once the reflector 11 is clamped securely, any gaps shown in FIG. 3 between the retaining section 40 and the collar 13, or between the collar 13 and the flange 29, are eliminated.

When the ring 30 is released or loosened, the reflector 11 is able to rotate about its center longitudinal axis M. The retaining section 40 of the ring 30 here prevents the reflector 11 from falling out of the fixture housing 26, thus securing the pre-installed position of the reflector 11 on the fixture housing 26. This last-made observation becomes clear when it is realized that FIG. 3 shows only one out of many different possible installation situations. For example, in the case of a ceiling mount as in FIG. 2 the reflector 11 could fall out of the fixture housing 26. This is effectively prevented by the retaining section 40 of the ring 30. Once the desired illuminated zone 25 on the building wall 19 to be illuminated is obtained after rotation of the reflector 11, the ring 30 can be screwed down and the reflector 11 thus clamped securely. This then secures the obtained angular position of the reflector 11.

In the event repositioning is desired, the only requirement is to loosen ring element 30, turn the reflector 11, and once again screw down the ring 30.

The reflector 11 has an outside diameter MA that is slightly smaller than an inside diameter MI of the fixture housing 26. With the ring 30 loosened, the reflector 11 is thus able to be inserted in an insertion direction E into the mounting seat formed by the shoulder 34.

An alternative embodiment of a light fixture according to the invention is illustrated in FIG. 4: Here a spring 41 is provided between the flange 29 and the collar 13 of the reflector 11. The spring 41 is constituted as a compression spring and urges the collar 13 of the reflector 11 with the flange top face 38 against the retaining section 40 of the ring 30. Dashed line 42 simply shows that the ring 30 is made so as to be removable from the remaining parts of the housing 26. A screw connection or other attachment mode that requires clamp-locking is not absolutely necessary, however. Instead, for example, a removable attachment means of any design, e.g. analogous to a detent-type connection, can be employed here.

Finally, it is also possible to insert the reflector into the fixture housing not in insertion direction E, as provided in the embodiment of FIG. 3, but from the opposite side. To this end, the flange 29 must, however, be designed so as to be outwardly expandable or radially displaceable or removably attachable.

The functional principle of the light fixture 10 in FIG. 4 is as follows:

In response to the application of pressure, the reflector 11 can be slightly displaced against the force of springs 42, thereby enabling the collar 13 to be shifted at least slightly off the retaining section 40. The reflector 11 can then be rotated about its center longitudinal axis M until the desired orientation of the illuminated zone 25 on the building wall 19 is achieved. Releasing the reflector 11 enables springs 42 to again act on the reflector 11 opposite a pressure-application direction D, and to press the collar 13 against the retaining section 40. The adjusted angular position of the reflector 11 can thus be secured and maintained in a lasting manner.

It should be noted that FIG. 4 shows two springs 41 simply for explanatory purposes. The number of springs here is of course not important. Instead of compression springs or helical springs, tension springs can of course also be employed. Finally, the spring force can also be produced by a compressible material, e.g. a soft-elastic rubber insert or another appropriate compressible element that exerts reset forces.

FIG. 5 shows the reflector 11 in a view like FIG. 1, where here a first angular-positioning formation 43 is provided. This formation is a groove of triangular cross-section cut into the collar 13 of the reflector 11.

FIG. 6 is a top view showing the associated fixture housing 26 with the indicated lamp socket 36 and the light source 35. This view results, for example, if one imagines a perspective of the viewer of FIG. 3 in insertion direction E toward the fixture housing 26, where the reflector and retaining the ring 30 have been omitted, and where it must be noted that the fixture housing in FIG. 6 of course relates to a different fixture housing than that of FIG. 3.

In FIG. 6, the support shoulder, which is formed by the flange 29 projecting radially inward from housing wall 28, is shown as hatched. The hatching is intended only to indicate the viewed surface, not a cross-sectional area.

A radially inwardly projecting lug 44 is formed on the lower region of FIG. 6 as the second formation. Analogous to a coding lug, this can interact with the groove 43 of the reflector 11. When the reflector of FIG. 5 is inserted into the interior of the fixture housing 26 of FIG. 6, the appropriate mounting seat, that is, the support shoulder 29 can only be reached when the groove 43 and lug 44 are moved so as to be aligned. As a result, the angular position of the reflector 11 is fixed and clearly defined relative to the fixture housing.

It must be noted that, for purposes of better comprehensibility, FIG. 7 illustrates the embodiment of FIG. 6 in an enlarged partial-sectional cut-away view along section line VII-VII of FIG. 6. This view corresponds to that of the embodiment of FIG. 3, or of the divided circle denoted there by VII. The external thread arrangement 31 shown in FIG. 3 and separate the ring 30 are not shown in the other embodiment of FIG. 7. However, a thread or the ring 30 can be similarly provided in an embodiment of FIGS. 5 through 7.

Due to the design of the reflector 11 with the first angular-positioning formation 43, and to the design of the fixture housing 26 with the second formation 44, installation of the reflector 11 into the fixture housing 26 is possible only in one single rotational position. In the event a specific rotational alignment of the illuminated zone 25 is already predetermined, this aspect is able to ensure the non-interchangeable insertion of the reflector.

FIG. 8 illustrates in a second embodiment of the reflector 11 according to the invention, analogous to FIG. 5, that multiple angular-positioning formations 43a, 43b, 43c, 43d, 43e, 43f, 43g can be provided on the reflector 11. These equidistant angular-positioning formations offset at 30° angles enable the reflector 11 of FIG. 8 to be inserted into the fixture housing 26 of FIG. 6 at eight different angular positions. FIG. 8 illustrates that the reflector 11 of FIG. 8 is insertable along an angular region of 180° in 30° steps. The number of angular-positioning formations 43a, 43b, 43c, 43d, 43e, 43f, 43g on the reflector 11 and the angular distance determine the variability for the installation of this reflector. Smaller or different angular steps are also possible as required.

Finally, FIG. 9 shows another embodiment of a reflector in a view based on FIG. 8. Here rotation through a 90° angle is provided. To this end, a 90° recess 45 is mounted in the collar 13 of the reflector 11. The reflector 11 of FIG. 9 is insertable into the fixture housing 26 of FIG. 6 and is rotatable only along a 90° angular region.

Recess 45 can of course extend along any desired angular region. It is possible, for example, for multiple notches 45 extending along an angular region to be provided on the reflector 11, which recesses allow rotation along a given angle within limited swivel stops.

The above descriptions make it evident that the first angular-positioning formation can also be formed by the ring 30 and can interact with a housing second formation 44. Finally, it is also possible for the ring 30 and the fixture housing 26 to be attachable to each other only in a single predefined relative angular orientation. In this case, provision can be made whereby the reflector 11 is provided with an angular-positioning formation, while the ring 30 is provided with a second formation.

Finally, it must be pointed out that a sectional view of the reflector 11 in FIG. 3 can result both when viewing section line III-III in FIG. 1 as well as, for example, when viewing section line IIIa-IIIa in FIG. 1. FIG. 3 identifies, by way of example, three segments 15a, 15b, 15c whose inwardly facing surfaces reflect the light emitted by light source 35 and direct this light onto the building surfaces 19 to be illuminated. This light is reflected differently depending on how the surface of individual segments 15a, 15b, 15c is constituted. Each surface of each individual segment 15a, 15b, 15c is individually computed and can differ from the surface of an adjacent segment.

It should also be noted that FIG. 1, as described above, illustrates a different segment configuration along an angular region α than in the remaining angular region. Even given differences in the reflector curvatures that are not evident to a viewer on first glance, that is, given an apparently uniform design of the inside of the reflector, the surfaces can nevertheless be shaped differently such that a rotationally asymmetrical illuminated zone on a building surface can be obtained with the reflector.

It should furthermore be noted that the retaining rings or retaining bodies 30 provided in the embodiments of FIGS. 3 and 4 are removably attachable to the fixture housing 26, and in the attached state ensure a pre-installed position for the reflector 11 on the fixture housing. This is possible since each ring 30 has a retaining section 40 that axially secures the reflector.

Finally, it should be also noted that a first angular-positioning formation 43 can also be provided on the fixture housing, and a second formation 44 provided on the reflector. For example, a recess 43 can thus also be provided on the fixture housing, while a corresponding lug or corresponding projection 44 can be provided on the reflector.

Finally, provision is made in an embodiment not shown whereby the reflector is rotatably supported in its mounting seat. The rotational motion can be unrestricted, i.e., allowed by more than 360°, or be limited by rotational stops. In this unillustrated embodiment not shown, a reflector positioning formation and housing formation can be provided despite the allowable rotation relative to its housing-side mounting seat. They can be for example purely visually detectable indicia that can be made to coincide by the service person without preventing rotation of the reflector.

1. A light fixture for illuminating a building surface and having a fixture housing holding a bowl-shaped reflector with a generally rotation-symmetrical outer surface centered on a longitudinal center axis and an inner surface provided with a plurality of segments for producing a rotationally asymmetrical illuminated zone wherein the fixture housing has a rotary bearing for the reflector so as to enable rotation of the reflector about its central longitudinal axis, and a device is provided on the fixture housing for rotationally arresting the reflector, the device fixing the reflector relative to the fixture housing in any of a plurality of angularly offset positions.

2. The light fixture according to claim 1 wherein the bearing has shoulders.

3. The light fixture according to claim 2 wherein the shoulders are provided at three separate locations.

4. The light fixture according to claim 1 wherein the reflector has a free edge that has a collar.

5. The light fixture according to claim 1 wherein the device has a clamping surface pressable against an opposite clamping surface of the reflector.

6. The light fixture according to claim 1 wherein the device has at least one spring for exerting a clamping force.

7. The light fixture according to claim 4 wherein, when the angular position of the reflector is fixed, the collar is between the collar clamping surface and the opposite clamping surface.

8. The light fixture according to claim 5, wherein the collar clamping surface or the opposite clamping surface are formed by an element that is removably mounted on the fixture housing.

9. The light fixture according to claim 1 wherein the segments each have a surface curved toward an interior of the reflector.

10. The light fixture according to claim 1 wherein a lamp is provided in an interior of the reflector.

11. The light fixture according to claim 1 wherein at an apex of the reflector there is an installation aperture.

12. The light fixture according to claim 11 wherein the installation aperture has an inside diameter that is larger than an outside diameter of the lamp.

13. A light fixture for illuminating a building surface and having a fixture housing having a seat holding a bowl-shaped reflector with a generally rotation-symmetrical outer surface centered on a longitudinal center axis and an inner surface provided with a plurality of segments for producing a rotationally asymmetrical illuminated zone wherein the reflector has a first angular-positioning formation and the seat has at least one second angular-positioning formation to set a defined angular position of the reflector relative to the housing.

14. The light fixture according to claim 13 wherein the reflector can only be fitted to the seat when it is an angular position in which the first positioning formation is a aligned with the second positioning formation.

15. The light fixture according to claim 13 wherein the angular-positioning formation are provided on a free edge of the reflector, in particular on a collar of the reflector.

16. The light fixture according to claim 13 wherein the first angular-positioning formation or the second angular-positioning formation is formed by a groove or by a lug.

17. The light fixture according to claim 13 wherein a plurality of angular-positioning formations and/or a plurality of second formations are provided.

18. The light fixture according to claim 17 wherein a plurality of first angular-positioning formations and/or a plurality of second formation are equispaced.

19. A reflector that is generally bowl shaped ant that has an outer surface generally rotation-symmetrical to a longitudinal center axis and an inner surface provided with a plurality of segments that produce a rotationally asymmetrical illuminated zone wherein a free edge of the reflector has at least one angular-positioning formation.
